(19) United States
(12) Patent Application Publication
(10) Pub. No.: US 2014/0207758 A1
(43) Pub. Date: Jul. 24, 2014

(54) Thread Object-Based Search Method and Apparatus

(71) Applicant: Huawei Technologies Co., Ltd., Shenzhen (CN)

(72) Inventors: Liangbing Lu, Hangzhou (CN); Lijue Wang, Hangzhou (CN)

(73) Assignee: Huawei Technologies Co., Ltd., Shenzhen (CN)

(21) Appl. No.: 14/079,839

(22) Filed: Nov. 14, 2013

Related U.S. Application Data
(63) Continuation of application No. PCT/CN2013/080668, filed on Aug. 1, 2013.

(30) Foreign Application Priority Data
Jan. 24, 2013 (CN) 201310027530.0

(51) Int. Cl. G06F 17/30

(52) U.S. Cl. CPC G06F 17/30554
USPC 707/722; 707/755

(57) ABSTRACT

Embodiments of the present invention provide a thread object-based search method and apparatus and relate to the field of communications technologies. The method includes: receiving at least one thread object dragged by a user to a search area, where the search area is located on a current page of a web page; parsing the at least one thread object to obtain at least one attribute of the at least one thread object; searching by using the at least one attribute as a keyword; and displaying results obtained by performing the searching. The present invention is applicable to an intelligent terminal.

### CROSS-REFERENCE TO RELATED APPLICATIONS

This application is a continuation of International Application No. PCT/CN2013/080668, filed on Aug. 1, 2013, which claims priority to Chinese Patent Application No. 201310027530.0, filed on Jan. 24, 2013, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of communications technologies, and in particular, to a thread object-based search method and apparatus.

### BACKGROUND

With the development of smart phones and Internet technologies, a smart phone user can access the Internet by using a mobile phone anytime and anywhere to obtain desired information. A search website is a main way for the user to obtain Internet information. During searching, the user needs to enter a keyword in a search bar of the search website, and then finds desired information directly or indirectly from a result list.

When entering a keyword, the user needs to enter the keyword in a narrow space by using a soft keyboard, and the input efficiency is low. In addition, during the searching, search is only related to the entered keyword and obtained results are restricted to information related to the keyword. If the user enters an inaccurate keyword, the user cannot find his/her desired information, and the search efficiency is low, thereby affecting user experience.

### SUMMARY

Embodiments of the present invention provide a thread object-based search method and apparatus, which can solve a low search efficiency problem in an existing search process, increase the search efficiency, and improve user experience.

According to a first aspect, a thread object-based search method is provided, including: receiving at least one thread object dragged by a user to a search area, where the search area is located on a current page of a web page; parsing the at least one thread object to obtain at least one attribute of the at least one thread object; searching by using the at least one attribute as a keyword; and displaying results obtained by performing the searching.

In a first possible implementation manner, before, when, or after the displaying results obtained by performing the searching, the method further includes: displaying the keyword; after the displaying the keyword, the method further includes: receiving a deletion instruction from the user, where the deletion instruction is used to delete a keyword corresponding to the deletion instruction.

Further, after the receiving a deletion instruction from the user, the method further includes: deleting the keyword corresponding to the deletion instruction according to the deletion instruction, so that the quantity of the results is reduced and a search scope is narrowed.

With reference to the first aspect, in a second possible implementation manner, after the displaying results obtained by performing the searching, the method further includes: receiving a drag instruction from the user; and moving at least one of the results to the search area according to the drag instruction.

Further, after the moving at least one of the results to the search area according to the drag instruction, the method further includes: parsing the at least one of the results as a thread object to obtain at least one attribute of the at least one of the results; searching by using the at least one attribute as a keyword; and displaying results obtained by performing the searching.

With reference to the first aspect, the first possible implementation manner of the first aspect or the second possible implementation manner of the first aspect, in a third possible implementation manner, the thread object includes a video, an audio, an image or a text.

With reference to the first aspect, the first possible implementation manner of the first aspect, the second possible implementation manner of the first aspect or the third possible implementation manner of the first aspect, in a fourth possible implementation manner, the attribute includes a title of the thread object, an author of the thread object, a type of the thread object, and a tag of the thread object.

According to a second aspect, a thread object-based search apparatus is provided, including: a receiving unit configured to receive at least one thread object dragged by a user to a search area; a parsing unit configured to parse the at least one thread object received by the receiving unit to obtain at least one attribute of the at least one thread object; a searching unit configured to search by using the at least one attribute parsed by the parsing unit as a keyword; and a displaying unit configured to display results obtained after the searching unit performs the searching.

In a first possible implementation manner, the displaying unit is further configured to: display the keyword; after the displaying unit displays the keyword, the receiving unit is further configured to receive a deletion instruction from the user, where the deletion instruction is used to delete a keyword corresponding to the deletion instruction.

Further, the apparatus further includes: a deleting unit configured to delete the keyword corresponding to the deletion instruction according to the deletion instruction received by the receiving unit, so that the quantity of the results is reduced and a search scope is narrowed.

In a second possible implementation manner, the receiving unit is further configured to receive a drag instruction from the user; the apparatus further includes: a moving unit configured to move at least one of the results to the search area according to the drag instruction received by the receiving unit.

Further, after the moving unit moves the at least one of the results to the search area, the parsing unit is further configured to parse the results as a thread object to obtain at least one attribute of the results.

The searching unit is further configured to search by using the at least one attribute parsed by the parsing unit as a keyword.

The displaying unit is further configured to display results obtained after the search unit performs the searching.

With reference to the second aspect, the first possible implementation manner of the second aspect or the second possible implementation manner of the second aspect, in a third possible implementation manner, the thread object includes a video, an audio, an image or a text.

With reference to the second aspect, the first possible implementation manner of the second aspect, the second possible implementation manner of the second aspect or the third possible implementation manner of the second aspect, in a fourth possible implementation manner, the attribute includes a title of the thread object, an author of the thread object, a type of the thread object, and a tag of the thread object.

Compared with the prior art, the embodiments of the present invention can increase the search efficiency of a user of a terminal in the following two aspects: on the one hand, an object that needs to be searched can be directly dragged to a specific search area, and the terminal automatically parses the object received in the specific search area and extracts a keyword, which replaces a step of entering a keyword manually by the user and increases the user's input efficiency; on the other hand, multiple associated keywords can be extracted according to an object, for example, an author, a title, a type of one video object, and an expanded search is provided for the user on the basis of an existing search, which can help the user search out associated content and increase a success rate of finding desired information of the user, thereby increasing the search efficiency.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method according to Embodiment 1 of the present invention;

FIG. 2 is a schematic diagram of a search page according to Embodiment 1 of the present invention;

FIG. 3 is a schematic diagram of a search result page according to Embodiment 1 of the present invention;

FIG. 4 is a flowchart of a method according to Embodiment 2 of the present invention;

FIG. 5 and FIG. 6 are schematic structural diagrams of an apparatus according to Embodiment 3 of the present invention; and

FIG. 7 is a schematic structural diagram of a terminal according to Embodiment 4 of the present invention.

### DETAILED DESCRIPTION

The following clearly describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

To make the advantages of the technical solutions of the present invention more comprehensible, the following further describes the present invention in detail with reference to the accompanying drawings and embodiments.

### Embodiment 1

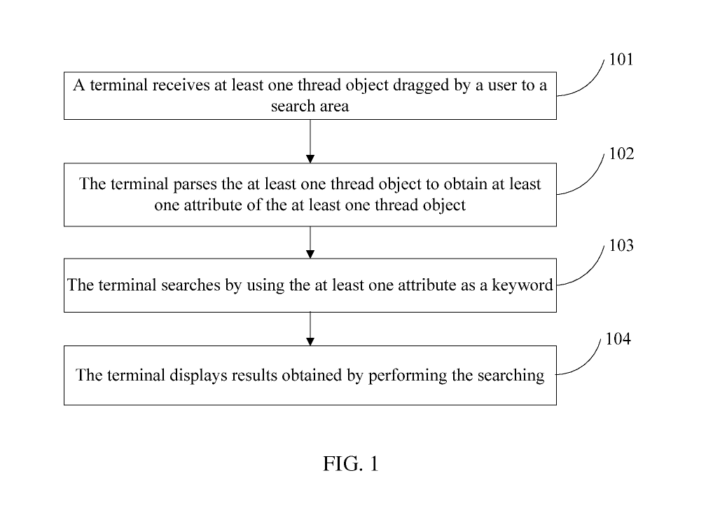

This embodiment provides a thread object-based search method. As shown in FIG. 1, the method includes the following steps:

101. A terminal receives at least one thread object dragged by a user to a search area.

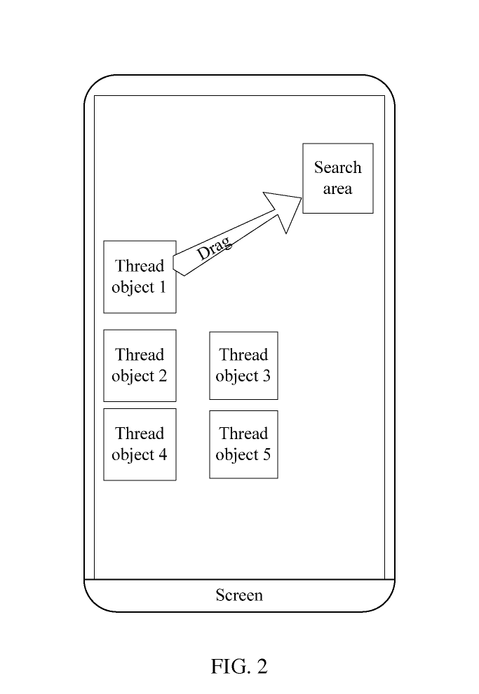

The search area is located on a current page of a web page, and the scope of the search area is less than the size of the current page. When the user flicks the web page up and down, the search area always remains on the current page of the screen. The position and shape of the search area on the current page may be set by the user. For example, as shown in FIG. 2, the search area may be a rectangular area with a proper size, and alternatively, may be another shape. The specific size of the area may be adjusted according to the size of the terminal screen and actual needs of the user. During operations, the user drags a thread object with a finger to the search area.

102. The terminal parses the at least one thread object to obtain at least one attribute of the at least one thread object.

The thread object may be a video, an audio, an image or a text of the web page, for example, a video in a video list on the Youku website or a music album on the website. Alternatively, the attribute of the thread object may be at least one of the following information: a title, an author, a type and a tag of a video, an audio, a text or an image, or the attribute of the thread object may be the thread object itself, for example, when the thread object is a text, the text may be directly used as a keyword to search.

103. The terminal searches by using the at least one attribute as a keyword.

Alternatively, when multiple attributes are parsed out, the user can screen these attributes, and use a screened result as a keyword, or, the user can directly use all the attributes as a keyword.

104. The terminal displays results obtained by performing the searching.

Optionally, before, when or after displaying results obtained by performing the searching, the method further includes displaying the keyword.

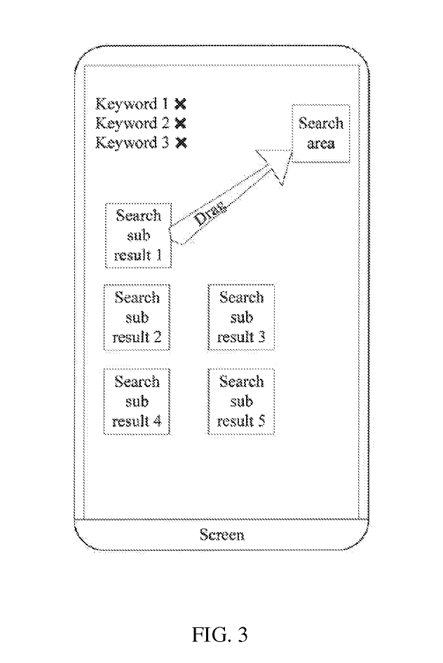

For example, as shown in FIG. 3, keywords and results are displayed on a result displaying page.

Optionally, after displaying the keywords, the method further includes receiving a deletion instruction from the user, where the deletion instruction is used to delete a keyword corresponding to the deletion instruction.

Further, after receiving the deletion instruction from the user, the method further includes: deleting the keyword corresponding to the deletion instruction according to the deletion instruction, so that the quantity of the results is reduced and a search scope is narrowed.

Optionally, when the user thinks that one result may be used as a more accurate keyword, after the displaying results obtained by performing the searching, the method further includes: receiving a drag instruction from the user; and moving at least one of the results to the search area according to the drag instruction.

Further, after moving at least one of the results to the search area according to the drag instruction, the method further includes:

Parsing the at least one of the results as a thread object to obtain at least one attribute of the at least one of the results; searching by using the at least one attribute as a keyword; and displaying results obtained by performing the searching.

Compared with the prior art, the embodiment of the present invention can increase the search efficiency of a user of a terminal in the following two aspects: on the one hand, an object that needs to be searched can be directly dragged to a specific search area, and the terminal automatically parses the object received in the specific search area and extracts a keyword, which replaces a step of entering a keyword manually by the user and improves the user's input efficiency; on the other hand, multiple associated keywords can be extracted according to an object, for example, an author, a title, a type of one video object, and an expanded search is provided for the user on the basis of an existing search, which can help the user search out associated contents and increase a success rate of finding desired information of the user, thereby increasing the search efficiency.

### Embodiment 2

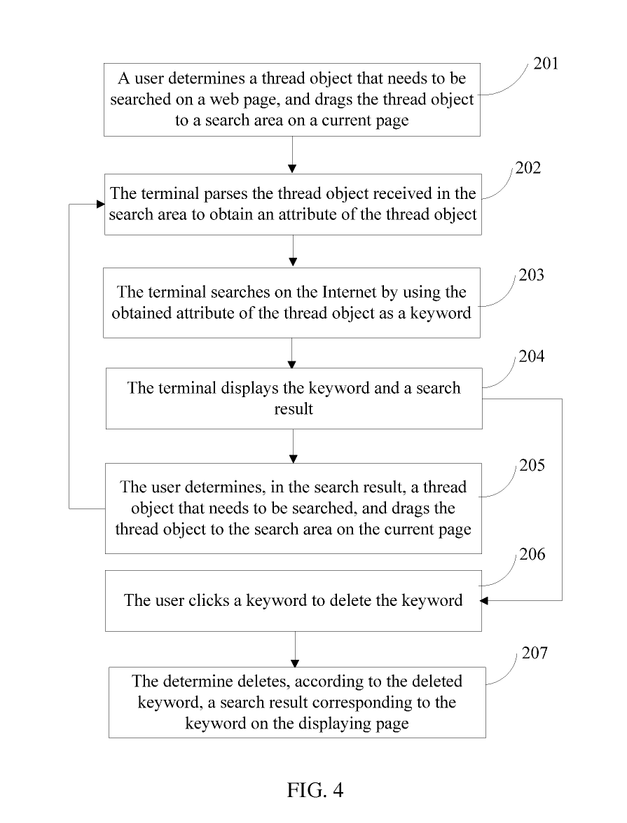

This embodiment provides a thread object-based search method. As shown in FIG. 4, the method includes the following steps:

201. A user determines a thread object that needs to be searched on a web page, and drags the thread object to a search area on a current page.

The scope of the search area is less than the size of the current page. When the user flicks the web page up and down, the search area always remains on the current page of the screen. The position and shape of the search area on the current page may be set by the user. Alternatively, the search area may be fixed at a position of the terminal screen, and may also be dragged by the user to any position.

For example, in FIG. 2, the search area may be a rectangular area with a proper size, and alternatively, may be another shape. The size of the area may be adjusted according to the size of the terminal screen and actual needs of the user. The user can use a finger to press the pane of the search area to zoom in or out and adjust the size of the area. When selecting a search object, the user uses a finger to drag the thread object to the search area.

Alternatively, when the user selects a thread object, the user can select only one thread object or multiple thread objects.

202. The terminal parses the thread object received in the search area to obtain an attribute of the thread object.

Alternatively, when receiving multiple thread objects selected by the user, the terminal parses the thread objects according to a receiving sequence.

The thread object may be a video, an audio, an image or a text of the web page, for example, a video on the Youku website or a music album on the website. Alternatively, the attribute of the thread object may be at least one of the following information: a title, an author, a type and a tag of a video, an audio, a text or an image, or the attribute of the thread object may be the thread object itself, for example, when the thread object is a text, the text may be directly used as a keyword to search.

203. The terminal searches on the Internet by using the obtained attribute of the thread object as a keyword.

During the searching, the terminal performs individual searching with respect to each keyword to obtain a corresponding result.

Alternatively, when parsing the thread object and obtaining multiple attributes, the terminal can prompt the user to screen these attributes and use an attribute selected by the user as a keyword, or to directly use all the attributes as a keyword.

204. The terminal displays the keyword and a search result.

For example, as shown in FIG. 3, the keyword and search result are displayed on a displaying page of the searching result, where the search result is a set of all results obtained by performing the searching according to all keywords.

Alternatively, when the user thinks that the search result does not satisfy his/her requirement, step 205 is executed, and the terminal selects from the search result a result closer to desired information of the user as a thread object, and then re-executes step 202 to step 204.

205. The user determines a thread object that needs to be searched in the search result, and drags the thread object to a search area on a current page.

Alternatively, when the user thinks that the search scope is excessively wide and the quantity of search results is excessively large, step 206 to step 207 are executed after step 204. The terminal deletes some keywords on the page to narrow down the search scope and help the user quickly find a proper search result.

206. The user clicks a keyword to delete the keyword.

207. The terminal deletes, according to the deleted keyword, a search result corresponding to the keyword on the displaying page.

Compared with the prior art, the embodiment of the present invention can increase the search efficiency of a user of a terminal in the following two aspects: on the one hand, an object that needs to be searched can be directly dragged to a specific search area, and the terminal automatically parses the object received in the specific search area and extracts a keyword, which replaces a step of entering a keyword manually by the user and improve the user's input efficiency; on the other hand, multiple associated keywords can be extracted according to an object, for example, an author, a title, a type of one video object, and an expanded search is provided for the user on the basis of an existing search, which can help the user search out associated contents and increase a success rate of finding desired information of the user, thereby increasing the search efficiency.

### Embodiment 3

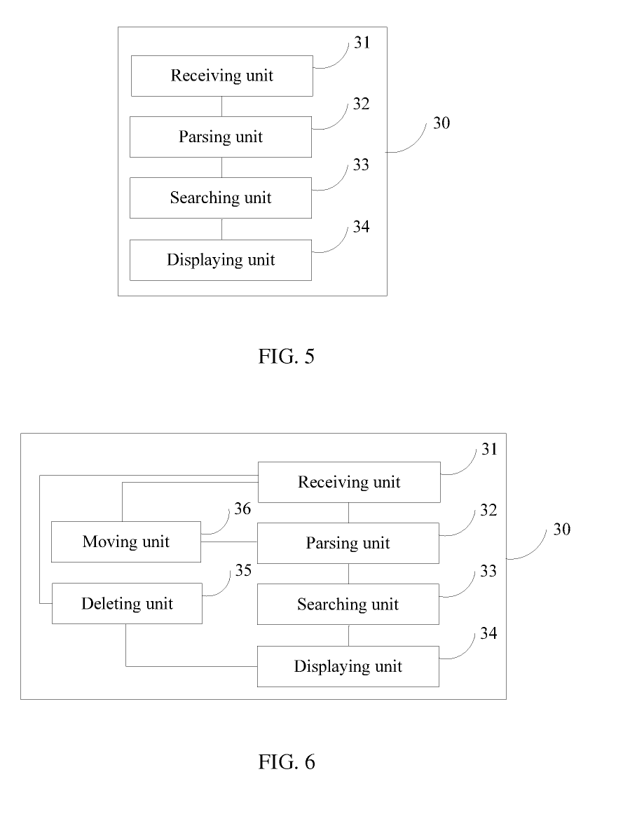

This embodiment provides a thread object-based search apparatus 30. As shown in FIG. 5, the apparatus 30 includes: a receiving unit 31 configured to receive at least one thread object dragged by a user to a search area; a parsing unit 32 configured to parse the at least one thread object received by the receiving unit 31 to obtain at least one attribute of the at least one thread object; a searching unit 33 configured to search by using the at least one attribute parsed by the parsing unit 32 as a keyword; and a displaying unit 34 configured to display results obtained after the searching unit 33 performs the searching.

Further, the displaying unit 34 is further configured to display the keyword.

After the displaying unit 34 displays the keyword, the receiving unit 31 is further configured to receive a deletion instruction from the user, where the deletion instruction is used to delete a keyword corresponding to the deletion instruction.

Further, as shown in FIG. 6, the apparatus 30 may further include: a deleting unit 35 configured to delete the keyword corresponding to the deletion instruction according to the deletion instruction received by the receiving unit 31, so that the quantity of the results is reduced and a search scope is narrowed.

Further, the receiving unit 31 is further configured to receive a drag instruction from the user. As shown in FIG. 6, the apparatus 30 further includes: a moving unit 36 configured to move at least one of the results to the search area according to the drag instruction received by the receiving unit.

Further, after the moving unit 36 moves the at least one of the results to the search area, the parsing unit 32 is further configured to parse the results as a thread object to obtain at least one attribute of the results.

The searching unit 33 is further configured to search by using the at least one attribute parsed by the parsing unit 32 as a keyword.

The displaying unit 34 is further configured to display results obtained after the search unit 33 performs the searching.

The thread object includes a video, an audio, an image or a text. The attribute includes at least one of a title, an author, a type, and a tag. The attribute includes a title of the thread object, an author of the thread object, a type of the thread object, and a tag of the thread object.

Compared with the prior art, the embodiment of the present invention can increase the search efficiency of a user of a terminal in the following two aspects: on the one hand, an object that needs to be searched can be directly dragged to a specific search area, and the terminal automatically parses the object received in the specific search area and extracts a keyword, which replaces a step of entering a keyword manually by the user and improves the user's input efficiency; on the other hand, multiple associated keywords can be expanded according to an object, for example, an author, a title, a type of one video object, and an extended search is provided for the user on the basis of an existing search, which can help the user search out associated contents and increase a success rate of finding desired information of the user, thereby increasing the search efficiency.

### Embodiment 4

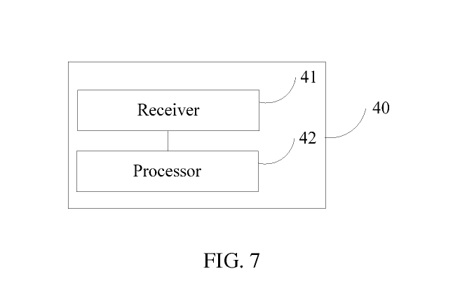

This embodiment provides a terminal 40. As shown in FIG. 7, the terminal 40 includes: a receiver 41 configured to receive at least one thread object dragged by a user to a search area; and a processor 42 configured to parse the at least one thread object received by the receiver 41 to obtain at least one attribute of the at least one thread object; search by using the at least one attribute as a keyword; and display results obtained by performing the searching.

Further, the processor 42 is further configured to display the keyword. After the processor 42 displays the keyword, the receiver 41 is further configured to receive a deletion instruction from the user, where the deletion instruction is used to delete a keyword corresponding to the deletion instruction.

The processor 42 is further configured to delete the keyword corresponding to the deletion instruction according to the deletion instruction received by the receiving unit 41, so that the quantity of the results is reduced and a search scope is narrowed.

Further, the receiver 41 is further configured to receive a drag instruction from the user.

The processor 42 is further configured to: move at least one of the results to the search area according to the drag instruction received by the receiver 41; parse the results as a thread object to obtain at least one attribute of the results; search by using the at least one attribute as a keyword; and display results obtained by performing the searching.

The thread object includes a video, an audio, an image or a text. The attribute includes at least one of a title, an author, a type, and a tag. The attribute includes a title of the thread object, an author of the thread object, a type of the thread object, and a tag of the thread object.

Such content as information interaction and execution processes between all units in the apparatus provided in this embodiment belong to the same idea as the method embodiments of the present invention. For details, reference may be made to the descriptions of the method embodiments of the present invention, which are not further described herein.

Compared with the prior art, the embodiment of the present invention can increase the search efficiency of a user of a terminal in the following two aspects: on the one hand, an object that needs to be searched can be directly dragged to a specific search area, and the terminal automatically parses the object received in the specific search area and extracts a keyword, which replaces a step of entering a keyword manually by the user and improves the user's input efficiency; on the other hand, multiple associated keywords can be expanded according to an object, for example, an author, a title, a type of one video object, and an extended search is provided for the user on the basis of an existing search, which can help the user search out associated contents and increase a success rate of finding desired information of the user, thereby increasing the search efficiency.

The thread object-based search apparatus provided by the embodiment of the present invention can implement the foregoing method embodiments. For details about specific functions of the thread object-based search apparatus, reference may be made to the descriptions of the method embodiments, which are not further described herein. The thread object-based search method and apparatus provided by the embodiments of the present invention can be applicable to an intelligent terminal, but is not limited thereto.

A person of ordinary skill in the art may understand that all or a part of the processes of the methods in the embodiments may be implemented by a computer program instructing relevant hardware. The program may be stored in a computer readable storage medium. When the program runs, the processes of the methods in the embodiments are performed. The storage medium may be a magnetic disk, an optical disc, a read-only memory (ROM), or a random access memory (RAM).

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A thread object-based search method, comprising:
receiving at least one thread object dragged by a user to a search area, wherein the search area is located on a current page of a web page;
parsing the at least one thread object to obtain at least one attribute of the at least one thread object;
searching by using the at least one attribute as a keyword; and
displaying results obtained by performing the searching.

2. The method according to claim 1, wherein before, when, or after displaying the results obtained by performing the searching, the method further comprises displaying the keyword, and wherein after displaying the keyword, the method further comprises receiving a deletion instruction from the user, wherein the deletion instruction is used to delete a keyword corresponding to the deletion instruction.

3. The method according to claim 2, wherein after receiving the deletion instruction from the user, the method further comprises deleting the keyword corresponding to the deletion instruction according to the deletion instruction such that the quantity of the results is reduced and a search scope is narrowed.

4. The method according to claim 1, wherein after displaying the results obtained by performing the searching, the method further comprises:
receiving a drag instruction from the user; and
moving at least one of the results to the search area according to the drag instruction.

5. The method according to claim 4, wherein after moving the at least one of the results to the search area according to the drag instruction, the method further comprises:
parsing the at least one of the results as a threshold object to obtain at least one attribute of the at least one of the results;
searching by using the at least one attribute as a keyword; and
displaying results obtained by performing the searching.

6. The method according to claim 1, wherein the thread object comprises a video, an audio, an image or a text.

7. The method according to claim 1, wherein the attribute comprises a title of the thread object, an author of the thread object, a type of the thread object, and a tag of the thread object.

8. A thread object-based search apparatus, comprising:
a receiving unit configured to receive at least one thread object dragged by a user to a search area;
a parsing unit configured to parse the at least one thread object received by the receiving unit to obtain at least one attribute of the at least one thread object;
a searching unit configured to search by using the at least one attribute parsed by the parsing unit as a keyword; and
a displaying unit configured to display results obtained after the searching unit performs the searching.

9. The apparatus according to claim 8, wherein the displaying unit is further configured to display the keyword, and wherein after the displaying unit displays the keyword, the receiving unit is further configured to receive a deletion instruction from the user, wherein the deletion instruction is used to delete a keyword corresponding to the deletion instruction.

10. The apparatus according to claim 9, further comprising a deleting unit configured to delete the keyword corresponding to the deletion instruction according to the deletion instruction received by the receiving unit such that the quantity of the results is reduced and a search scope is narrowed.

11. The apparatus according to claim 8, wherein the receiving unit is further configured to receive a drag instruction from the user, and wherein the apparatus further comprises a moving unit configured to move at least one of the results to the search area according to the drag instruction received by the receiving unit.

12. The apparatus according to claim 11, wherein after moving the at least one of the results to the search area by the moving unit, the parsing unit is further configured to parse the at least one of the results as a threshold object to obtain at least one attribute of the at least one of the results, wherein the searching unit is further configured to search by using the at least one attribute parsed by the parsing unit as a keyword, and wherein the displaying unit is further configured to display results obtained after the searching unit performs the searching.

13. The apparatus according to claim 8, wherein the thread object comprises a video, an audio, an image or a text.

14. The apparatus according to claim 8, wherein the attribute comprises a title of the thread object, an author of the thread object, a type of the thread object, and a tag of the thread object.

15. A non-transitory computer-readable medium having computer usable instructions stored thereon for execution by a processor, wherein the instructions cause the processor to:
receive at least one thread object dragged by a user to a search area, wherein the search area is located on a current page of a web page;
parse the at least one thread object to obtain at least one attribute of the at least one thread object;
search by using the at least one attribute as a keyword; and
display results obtained by performing the search.

16. The non-transitory computer-readable medium according to claim 15, wherein before, when, or after the results obtained by performing the search are displayed, the instructions further cause the processor to display the keyword, and wherein after the keyword is displayed, the instructions further cause the processor to receive a deletion instruction from the user, wherein the deletion instruction is used to delete a keyword corresponding to the deletion instruction.

17. The non-transitory computer-readable medium according to claim 16, wherein after the deletion instruction from the user is received, the instructions further cause the processor to delete the keyword corresponding to the deletion instruction according to the deletion instruction such that the quantity of the results is reduced and a search scope is narrowed.

18. The non-transitory computer-readable medium according to claim 15, wherein after the results obtained by performing the search are displayed, the instructions further cause the processor to:
receive a drag instruction from the user; and
move at least one of the results to the search area according to the drag instruction.

19. The non-transitory computer-readable medium according to claim 18, wherein after the at least one of the results is moved to the search area according to the drag instruction, the instructions further cause the processor to:
parse the at least one of the results as a threshold object to obtain at least one attribute of the at least one of the results;
search by using the at least one attribute as a keyword; and
display results obtained by performing the searching.

20. The non-transitory computer-readable medium according to claim 15, wherein the thread object comprises a video, an audio, an image or a text.
